(19) United States
(12) Patent Application Publication
(10) Pub. No.: US 2005/0156849 A1
(43) Pub. Date: Jul. 21, 2005

(54) Flat panel display with built-in DC-DC converters

(76) Inventor: Wein-Town Sun, Longtan Township (TW)

Correspondence Address: RABIN & Berdo, PC, 1101 14TH STREET, NW, SUITE 500, WASHINGTON, DC, 20005, US

(21) Appl. No.: 11/052,842

(22) Filed: Feb. 9, 2005

(30) Foreign Application Priority Data
Aug. 31, 2003 (TW) 93126263

(51) Int. Cl. G09G 3/36

(52) U.S. Cl. 345/96

(57) ABSTRACT

A flat panel display includes a substrate, a matrix of pixel electrodes, and a driving device consisting of a driving circuit, and at least two positive DC-DC converters. The matrix of pixel electrodes are formed on the substrate. The driving circuit is formed on the substrate and includes a plurality of units for driving the pixel electrodes. The units may be grouped into at least two power-consumption groups. The at least two positive DC-DC converters are formed on the substrate to supply voltages to the at least two power-consumption groups, each having substantially equivalent current loading. The driving device is formed on the substrate using LTPS manufacturing process.

This application claims the benefit of Taiwan application Serial No. 93126263, filed Aug. 31, 2004, the subject matter of which is incorporated herein for reference.

### BACKGROUND OF THE INVENTION

1. Field of the Invention

The invention relates in general to a flat panel display with built-in DC-DC converters, and more particularly to a low-temperature polysilicon thin film transistor liquid crystal display (LTPS TFT LCD) with built-in DC-DC converters.

2. Description of the Related Art

Low-temperature polysilicon (LTPS) TFT technology has been widely applied to LCD because LTPS TFT is known to have 100 times higher mobility than a-Si TFT. Thus, it can carry out CMOS process on the glass substrate. Some significant advantages for p-Si over a-Si include the capability for integrating driving circuits on glass substrates, resulting a slimmer peripheral dimension and cheaper cost.

The LTPS TFT LCD utilizes DC-DC converters in a driving circuit to take the input voltage and either boosts or bucks the voltage to an output voltage for the driving circuit. Referring to FIG. 1 for showing a conventional DC-DC converter, the DC-DC converter 110 supplies determined voltage to the load 120. The equivalent circuit of the load 120 includes a resistor R_{load} and a capacitor C_{load}. The load current is I_{load}. The DC-DC converter 110, which includes transistors S1, S2, S3 and S4 and capacitors C_{boost} and C_{hold}, is for boosting the DC power V_{dc} into an output voltage V_{2×}.

As the LCD size increases, the power demand of a large screen LCD panel also increases. To provide sufficient power supply for a large screen LCD panel, it may need a larger area of DC-DC converter on the panel, inevitably increasing the cost and manufacturing difficulties. For this reason, it is still not common to find DC-DC converters built-in a large screen LCD panel even though the technology of LTPS TFT LCD has already been available.

Refer to FIG. 2A for showing the relationship between an output voltage of the DC-DC converter and the required area of the DC-DC converter corresponding to the output voltage. As shown in FIG. 2A, when the required load current I_{load} is 0.5 mA and the output voltage V_{2×} is 8V, the reference value k is 1, where k representing the area required by the DC-DC converter 110. However, if the required load current I_{load} is doubled to be 1 mA and with the same output voltage V_{2×} of 8V, then the reference value k will be increased to 4. In other words, the area required by the DC-DC converter 110 will be quadrupled if the load current I_{load} is doubled.

Refer to FIG. 2B for showing the relationship between the required area of the DC-DC converter and its performance. As shown in FIG. 2B, when the load current I_{load} outputted from the DC-DC converter 110 is 0.5 mA, its efficiency may reach 90%. By contrast, when the load current load is 1 mA and the reference value k is 4, its efficiency is only 70%. Consequently, in addition to the disadvantage of high demand of area, the conventional DC-DC converter also suffers from low efficiency when built-in a large screen LCD panel.

Accordingly, it has been an outstanding issue for LCD industry to find an efficient method to build-in a DC-DC converter in a large screen LCD panel without suffering from the aforementioned disadvantages.

### SUMMARY OF THE INVENTION

It is therefore an object of the invention to provide a DC-DC converter with a reduced area that can be easily built in a large screen LCD panel using the LTPS manufacturing technology.

The invention achieves the above-identified object by providing a flat panel display, which includes a substrate, a matrix of pixel electrodes, and a driving device consisting of a driving circuit, and at least two positive DC-DC converters. The matrix of pixel electrodes is formed on the substrate. The driving circuit formed on the substrate includes a plurality of units for driving the matrix of pixel electrodes. The units may be grouped into at least two power-consumption groups, each having substantially equivalent current loading. At least two positive DC-DC converters are formed on the substrate to provide voltages to the at least two power-consumption groups. And the driving device is formed on the substrate using LTPS manufacturing process.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a circuit diagram showing a conventional DC-DC converter.

FIG. 2A is a graph showing the relationship between an output voltage and an area of the conventional DC-DC converter as shown in FIG. 1.

FIG. 2B is a graph showing the relationship between an area of the DC-DC converter and its efficiency.

FIG. 3 is a schematic diagram showing a driving circuit built in a LTPS TFT LCD according to a first preferred embodiment of the invention.

FIG. 4 is a schematic diagram showing a driving circuit built in a LTPS TFT LCD according to a second preferred embodiment of the invention.

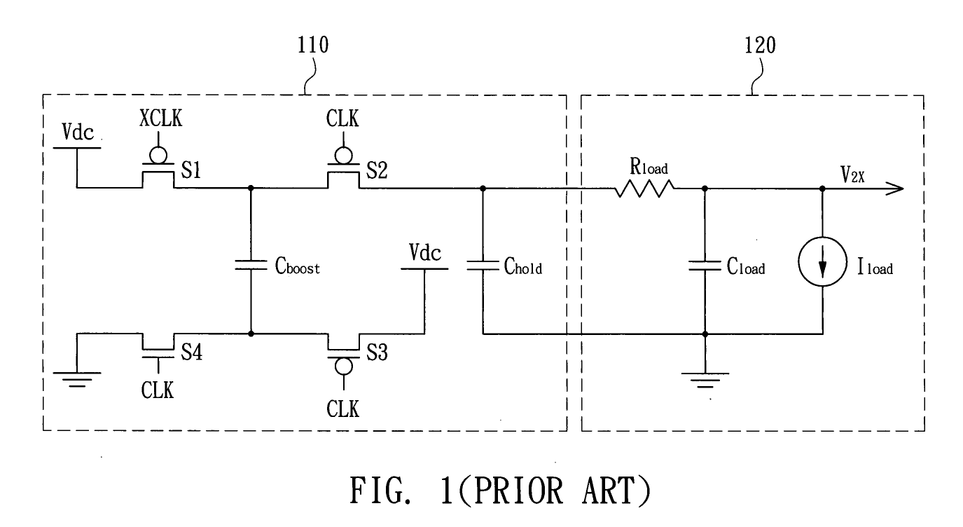

### DETAILED DESCRIPTION OF THE INVENTION

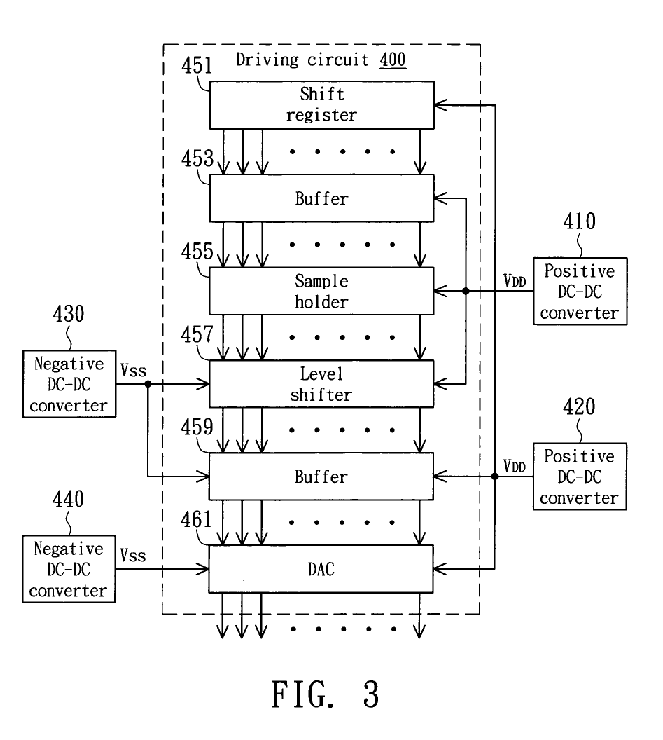

FIG. 3 is a schematic illustration showing a driving circuit built in a LTPS TFT LCD according to a first preferred embodiment of the invention. As shown in FIG. 3, the driving circuit 400 is formed on a substrate (not shown). Two positive DC-DC converters 410 and 420 supply positive voltages V_{DD}, and two negative DC-DC converters 430 and 440 supply negative voltages V_{SS}. The positive DC-DC converters 410 and 420 and the negative DC-DC converters 430 and 440 are formed on the substrate (not shown). Using the low-temperature polysilicon manufacturing (LTPS) manufacturing process, the pixel electrodes (not shown), the driving circuit 400, the positive DC-DC converters 410, 420, and the negative DC-DC converters 430, 440 all can be formed on the substrate (not shown).

The driving circuit 400 includes a plurality of units, such as, a shift register 451, a buffer 453, a sample holder 455, a level shifter 457, a buffer 459 and a DAC (Digital-to-Analog Converter) 461, for driving the matrix of pixel electrodes.

In this embodiment, the buffer 453, the sample holder 455 and the level shifter 457 are grouped into a first power-consumption group while the shift register 451, the buffer 459 and the DAC 461 are grouped into a second power-consumption group, each group having substantially equivalent current loading. In practical application, the number of power-consumption groups is not limited to two, and may be determined according to the various current loading of each unit in the driving circuit 400, allowing each power-consumption group to have substantially equivalent current loading.

Since the first embodiment of the present invention separates the conventional single positive DC-DC converter and the conventional single negative DC-DC converter into two groups respectively, so each group may supply voltages to the units of the power-consumption groups depending on their current loading.

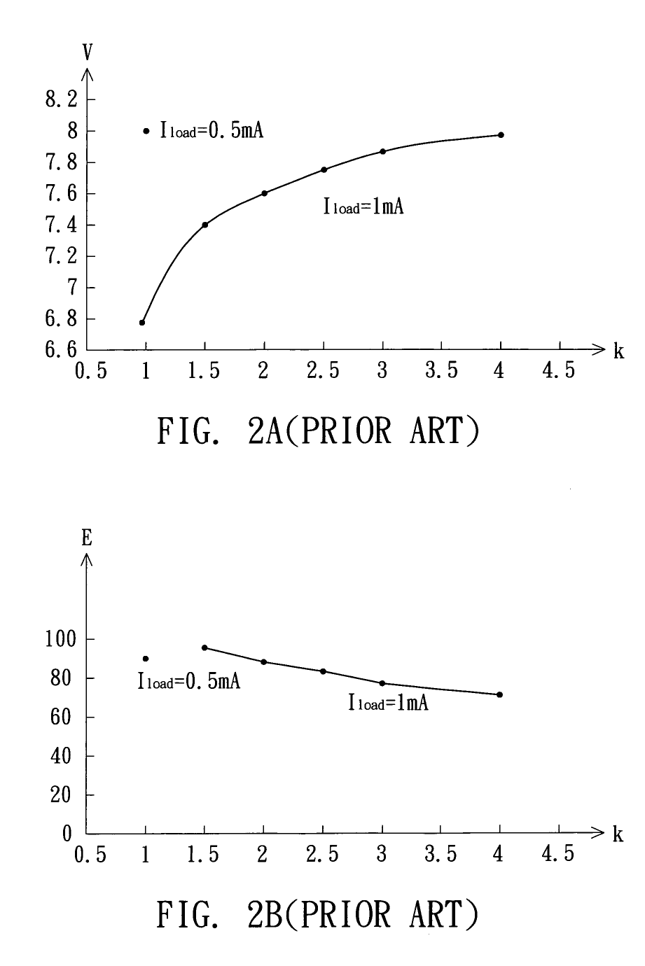

After the different power-consumption groups are defined, the reference value k which represents the area of each of the positive DC-DC converters 410 and 420 is 1, and each group of the DC-DC converters 410 and 420 outputs the current loading of 0.5 mA. Thus, the positive DC-DC converters 410 and 420 of this embodiment can totally provide the load current of 1 mA. Compared with the conventional configuration of FIG. 2A, the area of the first embodiment of the invention is only half of that of the conventional configuration while capable of supplying the same current of 1 mA.

Referring again to FIG. 2B, it shows that only one conventional DC-DC converter is used for supplying the current of 1 mA and the conversion efficiency is only about 70%. By contrast, since the first embodiment of the invention uses two positive DC-DC converters for supplying the current of 0.5 mA, the conversion efficiency of the first embodiment of the invention can reach about 90%.

Likewise, the advantage of the positive DC-DC converters 410, 420 also applies to the two negative DC-DC converters 430, 440. The reference value k, representing the area of each of the two negative DC-DC converters 430 and 440, is 1 with 0.5 mA output of the load current from DC-DC converters 430 and 440 respectively. Thus, the two negative DC-DC converters 430, 440 of this embodiment can totally provide the load current of 1 mA. The number of the load voltage DC-DC converters may be determined according to practical applications, and does not need to be proportional to the number of positive DC-DC converters.

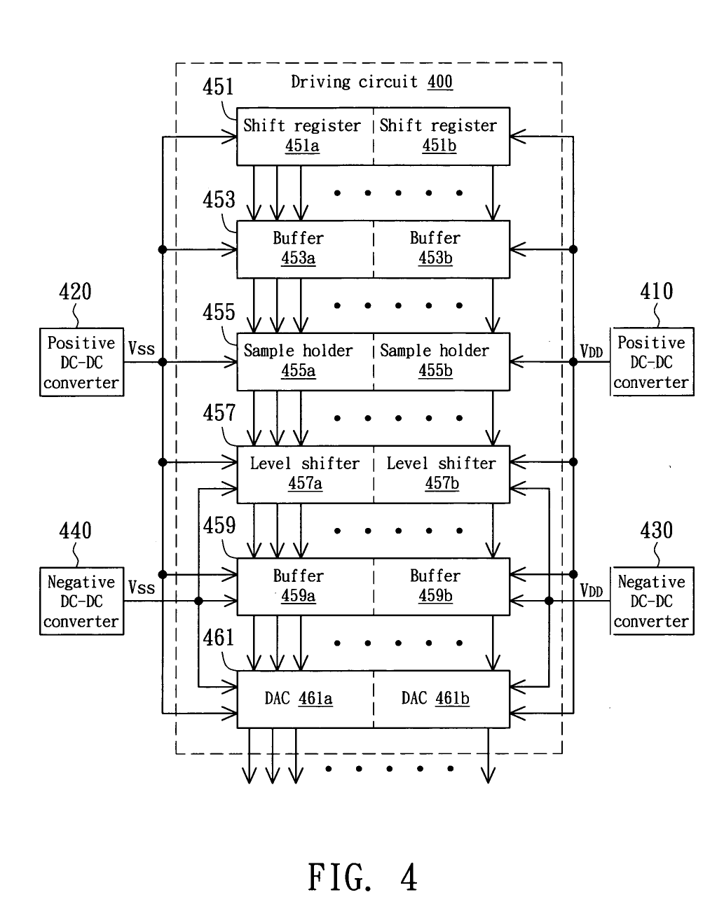

FIG. 4 is a schematic diagram showing a driving circuit built in a LTPS TFT LCD according to a second preferred embodiment of the invention. The second preferred embodiment is also manufactured by LTPS manufacturing process. It is different from the first preferred embodiment of the invention only in the grouping of the units of the driving circuit 400 as the first power-consumption group and the second power-consumption group. Each unit of the driving circuit 400 may be viewed as consisting of two half portions. As shown in FIG. 4, the shift register 451 consists of a first half shift registers 451a and a second half of shift register 451b. The buffer 453 also consists of a first half of buffers 453a and a second half of buffer 453b. The sample holder 455 consists of a first half of sample holder 455a and a second half of sample holder 455b. The level shifter 457 consists of a first half of level shifter 457a and a second half of level shifter 457b. The buffer 459 consists of a first half of buffer 459a and a second half of buffer 459b. The DAC 461 consists of a first half of DAC 461 a and a second half of DAC 461b.

In the second preferred embodiment of the invention, the positive DC-DC converter 420 supplies voltages to the first half of each unit of the driving circuit 400, including shift register 451a, buffer 453a, sample holder 455a, level shifter 457a, buffer 459a and DAC 461a. And the positive DC-DC converter 410 supplies voltages to the second half of each unit of the driving circuit 400, including the shift register 451b, buffer 453b, sample holder 455b, level shifter 457b, buffer 459b and DAC 461b.

On the other hand, the negative DC-DC converter 430 supplies power to the level shifter 457b, buffer 459b and DAC 461b. The negative DC-DC converter 440 supplies power to the level shifter 457a, buffer 459a and DAC 461a. The number of the negative DC-DC converters does not need to be proportional to the number of the positive DC-DC converters.

In addition to these two embodiments, there may be many other alternatives for grouping the units of the driving circuit as one power-consumption group depending on their actual current loading. It is suggested that each group has substantially equivalent current loading. Those ordinary skill in the art may freely modify the grouping rules according to the practical applications.

With the above mentioned advantages, the invention can be applied to LCD panels with built-in DC-DC converters using LTPS TFT LCD manufacturing process. Also, the invention can be applied to the display panel with built-in circuits, such as OLED (Organic Light Emitting Diode) display panel. In conclusion, the invention can effectively reduce the area of the DC-DC converters, thus making the built-in converters feasible in the panels, especially large screen LCD panels. Moreover, the built-in DC-DC converter allows an easier and cheaper integration of peripheral circuits on the glass substrate.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A flat panel display, comprising:
a substrate;
a matrix of pixel electrodes disposed on the substrate;
a driving circuit formed on the substrate having a plurality of units for driving the matrix of pixel electrodes, the plurality of units grouped as at least a first power-consumption group and a second power-consumption group;
a first positive DC-DC converter formed on the substrate for supplying voltages to the first power-consumption group; and
a second positive DC-DC converter formed on the substrate for supplying voltages to the second power-consumption group.

2. The flat panel display according to claim 1, further comprising:
at least one negative DC-DC converter formed on the substrate for selectively supplying voltage to the first power-consumption group or the second power-consumption group.

3. The flat panel display according to claim 1, wherein the driving circuit comprises: a shift register, a first buffer, a sample holder, a level shifter, a second buffer and a Digital-to-Analog Converter (DAC).

4. The flat panel display according to claim 1, wherein the first power-consumption group and the second power-consumption group have substantially equivalent current loading.

5. The flat panel display according to claim 1, wherein the first power-consumption group and the second power-consumption group are defined according to the two half portions of each unit of the driving circuits, and the two half portions of each unit having substantially equal current loading.

6. The flat panel display according to claim 1, wherein the pixel electrodes, the driving circuit, the first positive DC-DC converter and the second positive DC-DC converter are formed on the substrate by Low-Temperature PolySilicon (LTPS) manufacturing process.

7. The flat panel display according to claim 2, wherein the at least one negative DC-DC converter is formed on the substrate by Low-Temperature PolySilicon (LTPS) manufacturing process.

8. A flat panel display, comprising:
a substrate;
a matrix of pixel electrodes disposed on the substrate;
a driving circuit formed on the substrate having a plurality of units for driving the matrix of pixel electrodes, the plurality of units grouped as at least two power-consumption groups, each having substantially equivalent current loading; and
at least two positive DC-DC converters formed on the substrate for supplying voltages to the at least two power-consumption groups respectively.

9. The flat panel display according to claim 8, further comprising:
at least one negative DC-DC converter formed on the substrate.

10. The flat panel display according to claim 8, wherein the driving circuit comprises: a shift register, a first buffer, a sample holder, a level shifter, a second buffer and a Digital-to-Analog Converter (DAC).

11. The flat panel display according to claim 8, wherein the at least two power-consumption groups are defined according to the two half portions of each unit of the driving circuits, and the two half portions of each unit having substantially equal current loading.

12. A driving device for a flat panel display having a matrix of pixel electrodes formed on a substrate, comprising:
a driving circuit having a plurality of units formed on the substrate for driving the matrix of pixel electrodes, wherein the plurality of units are grouped as at least two power-consumption groups, each having substantially equivalent current loading; and
at least two positive DC-DC converters formed on the substrate for supplying voltages to the at least two power-consumption groups respectively.

13. The driving device for a flat panel display as claimed in claim 12, further comprising:
at least one negative DC-DC converter formed on the substrate for selectively supplying voltage to the at least two power-consumption groups.

14. The driving device for a flat panel display as claimed in claim 12, wherein the at least two power-consumption groups are defined according to the two half portions of each unit of the driving circuits, and the two half portions of each unit having substantially equal current loading.

15. The driving device for a flat panel display as claimed in claim 12, wherein the driving circuit, and the at least two positive DC-DC converters are formed on the substrate by Low-Temperature PolySilicon (LTPS) manufacturing process.

16. The driving device for a flat panel display as claimed in claim 13, wherein the at least one negative DC-DC converter is formed on the substrate by Low-Temperature PolySilicon (LTPS) manufacturing process.
